(19) United States
(12) Patent Application Publication
(10) Pub. No.: US 2012/0254186 A1
(43) Pub. Date: Oct. 4, 2012

(54) METHOD AND APPARATUS FOR RENDERING CATEGORIZED LOCATION-BASED SEARCH RESULTS

(75) Inventors: Caitlin Winner, Berlin (DE); Matthew Simon Biddulph, London (GB); Felix Petersen, Berlin (DE)

(73) Assignee: Nokia Corporation, Espoo (FI)

(21) Appl. No.: 13/098,724

(22) Filed: May 2, 2011

Related U.S. Application Data
(60) Provisional application No. 61/470,118, filed on Mar. 31, 2011.

(51) Int. Cl. G06F 17/30

(52) U.S. Cl. 707/740; 707/E17.09

(57) ABSTRACT

An approach is provided for rendering categorized location-based results. The approach involves determining a distribution of one or more entities over a geographical area. The approach further involves receiving an input for specifying one or more categories of the one or more entities. The approach also involves processing and/or facilitating a processing of the distribution to generate one or more clusters of the one or more entities with respect to the one or more categories. The approach further involves determining one or more geographical locations associated with the one or more clusters, the one or more entities, or a combination thereof. The approach also involves causing, at least in part, rendering or one or more graphical presentations of the one or more geographical locations, the one or more entities, or a combination thereof based, at least in part, on the one or more clusters.

### RELATED APPLICATION

This application claims the benefit of the earlier filing date under 35 U.S.C. §119(e) of U.S. Provisional Application No. 61/470,118 filed on Mar. 31, 2011 entitled “Method and Apparatus for Rendering Categorized Location-Based Search Results,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of interest relates to graphical presentation of search results in a map or augmented reality view so that points of interest that are the subject of the search can be rendered quickly and easily understood for comparison among other search results. The purpose being to aid a user in making a decision on whether to venture to one area or another based upon a plurality of reasons such as a number of points of interest or the quality of the points of interest available in an area, for example.

### SOME EXAMPLE EMBODIMENTS

Therefore, there is a need for an approach for expeditiously rendering results of a user queries for information.

According to one embodiment, a method comprises determining a distribution of one or more entities over a geographical area. The method also comprises receiving an input for specifying one or more categories of the one or more entities. The method further comprises processing and/or facilitating a processing of the distribution to generate one or more clusters of the one or more entities with respect to the one or more categories. The method also comprises determining one or more geographical locations associated with the one or more clusters, the one or more entities, or a combination thereof. The method further comprises causing, at least in part, rendering or one or more graphical presentations of the one or more geographical locations, the one or more entities, or a combination thereof based, at least in part, on the one or more clusters.

According to another embodiment, an apparatus comprises at least one processor, and at least one memory including computer program code for one or more programs, the at least one memory and the computer program code configured to, with the at least one processor, cause, at least in part, the apparatus to determine a distribution of one or more entities over a geographical area. The apparatus is also caused to receive an input for specifying one or more categories of the one or more entities. The apparatus is further caused to process and/or facilitate a processing of the distribution to generate one or more clusters of the one or more entities with respect to the one or more categories. The apparatus is also caused to determine one or more geographical locations associated with the one or more clusters, the one or more entities, or a combination thereof. The apparatus is further caused to render or one or more graphical presentations of the one or more geographical locations, the one or more entities, or a combination thereof based, at least in part, on the one or more clusters.

According to another embodiment, a computer-readable storage medium carries one or more sequences of one or more instructions which, when executed by one or more processors, cause, at least in part, an apparatus to determine a distribution of one or more entities over a geographical area. The apparatus is also caused to receive an input for specifying one or more categories of the one or more entities. The apparatus is further caused to process and/or facilitate a processing of the distribution to generate one or more clusters of the one or more entities with respect to the one or more categories. The apparatus is also caused to determine one or more geographical locations associated with the one or more clusters, the one or more entities, or a combination thereof. The apparatus is further caused to render or one or more graphical presentations of the one or more geographical locations, the one or more entities, or a combination thereof based, at least in part, on the one or more clusters.

According to another embodiment, an apparatus comprises means for determining a distribution of one or more entities over a geographical area. The apparatus also comprises means for receiving an input for specifying one or more categories of the one or more entities. The apparatus further comprises means for processing and/or facilitating a processing of the distribution to generate one or more clusters of the one or more entities with respect to the one or more categories. The apparatus also comprises means for determining one or more geographical locations associated with the one or more clusters, the one or more entities, or a combination thereof. The apparatus further comprises means for causing, at least in part, rendering or one or more graphical presentations of the one or more geographical locations, the one or more entities, or a combination thereof based, at least in part, on the one or more clusters.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of expeditiously rendering results of a user query for information, according to one embodiment;

FIG. 2 is a diagram of the components of a map processing platform, according to one embodiment;

FIG. 3 is a flowchart of a process for expeditiously rendering results of a user query for information, according to one embodiment;

FIG. 4 is a diagram of user interface illustrating a plurality of search results and respective clusters in a map, according to one embodiment;

FIG. 5 is a diagram of user interface illustrating a plurality of search results and respective clusters in a map and a categorization selector, according to one embodiment;

FIG. 6 is a diagram of user interface illustrating a plurality of search results and respective clusters in a list, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for expeditiously rendering results of a user query for information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

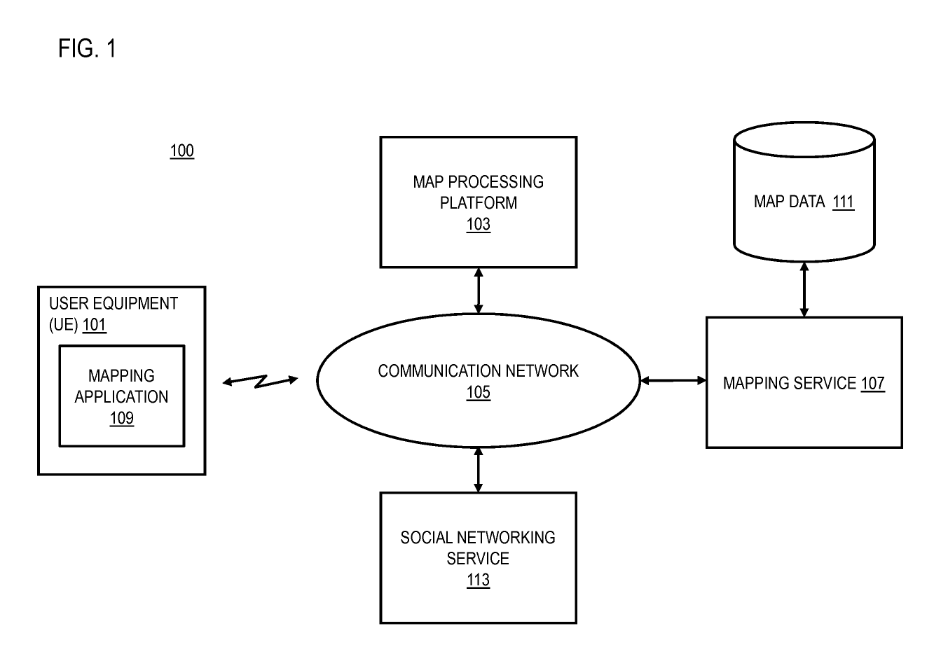

FIG. 1 is a diagram of a system capable of expeditiously rendering results of a user query for information, according to one embodiment. People travelling all over the world often need help finding the best places to go and things to do. People also generally base their decisions on where to go based on the availability of attractions of interest in those areas. For example, if a person likes to go out to eat, that person may want to travel to an area that has a lot of restaurants. So, a comprehensive view of available restaurants available in a particular area is desirable. But, it may be unreasonable to view a complete list of all of the restaurants available in a locality because they may be too numerous. Further, if a person searches for restaurants in a location, and is presented with an enormous list of results, it would be burdensome to look through all of the results to decide where to go. Also, it would be difficult for the person to compare areas that are near each other to decide where to go based on the number of restaurants that may be present in each area. Not to mention, some areas may have better restaurants than other areas, so there is a need to quickly view whether one area out ranks another based upon the quality of cuisine and/or the number of options available, for example.

To address this problem, a system 100 of FIG. 1 introduces the capability to process a query for information about one or more locations and quickly present that information in a manner that enables easy digestion and comparison with other queries for information about one or more other geographic locations. In embodiments, the claimed system and method provide an approach for searching for local attractions such as, but not limited to, restaurants, bars, hotels, movies, plays, shopping, amusement parks, libraries, sporting events and venues, etc.

In one embodiment, the approach may involve searching for items of interest in a geographic location and clustering the search results that are based on a user initiated query to enable a fast comprehensive view of what is available in a location and compare the availability to other geographic locations. For example, the search results may be populated on a map such that an indicator or icon is overlaid on a map with a number of hits within a particular radius or near a centerpoint of a search.

In certain embodiments, the approach involves compiling rating and review information about various local attractions that are available by way of a social networking service with information stored by a user and the user's own preferences to highlight areas having the best results. Best results may be determined based on a number of attributes such as ratings, number of hits in a particular location, ease of travel, etc. For example, a user in New York City may want to search for Italian restaurants in a location nearby. Of course there are a number of different areas in New York City that have Italian restaurants. The best Italian restaurants may be in Little Italy, but it may not be easy for the user to get there for the Upper West Side. So, a view of search results may show a number of results for Italian restaurants in the various districts of New York City, but it may highlight areas that are easier for the user to get to as being best results based on the location of the user.

In certain embodiments, the best results for Italian restaurants may be based on a resulting number of search results for the query. For example the approach may highlight an area such as Little Italy as having the highest concentration or most Italian restaurants within a particular proximity of New York City.

In certain embodiments, the approach may highlight areas with restaurants that have the highest ratings based on user experience, information stored in the system 100, or even information queried from a social networking or restaurant service, for example. The highlighting may also be based on the user's own preferences that may affect the search. For instance, if the user decides that he wants an Italian restaurant with the best wine selection, the user may contribute that to the search.

Similarly, the query and highlighting approach may be used for any type of attraction or information item relating to a location that may be of interest to a user. The approach may also generally query any internet source for specific information about the item of interest to be compiled and process the results.

A benefit to the highlighting, which may be done in any number of ways, is that it reduces the amount of data that must be sent to a user equipment (UE), thereby speeding the query/rendering process. For example, if a user searches for restaurants in various areas of a city, and each of the areas have hundreds of results, an indicator may be sent to the UE that highlights the area with the most results, and illustrates the number of results for each of the areas of the city. From this view, a user may then select an area to receive more details about the results of that particular area. But, because a limited high-level view of the search results is provided, only the amount of data necessary to present that view is needed at that time, and not data that would overwhelm the user and/or the UE.

As shown in FIG. 1, the system 100 comprises a user equipment (UE) 101 having connectivity to a map processing platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, a user may request information about a particular area to aid in a decision about whether to go to that area, or about what to do when in that area, for example. The user may input his query by way of a user interface into the UE 101. The UE 101 may communicate with a map processing platform 103 that sends a dataset to the UE 101 having search results that may be illustrated on a map that provides the search results in a graphical manner or in a list, for example, that illustrates the search results. The map processing platform 103 may communicate with a mapping service 107 that has information stored in a map data 111 about a particular location, such as restaurants, hotels, shopping centers, bars, theatres, etc. The mapping service may provide the stored information regarding the map data to the map processing platform for aggregation of results. The map processing platform may also communicate with a social networking service 113 to obtain information about a location such as ratings, reviews, rankings etc. about the area and any items of interest that may be located within the search area. The map processing platform may also communicate with other types of directory information such as the “Yellow Pages” or “OVI Places” to get names, addresses, telephone numbers, operating hours, photos, etc. about a point of interest or object of a search.

By way of example, the UE 101, map processing platform 103, mapping service 107 and social networking service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

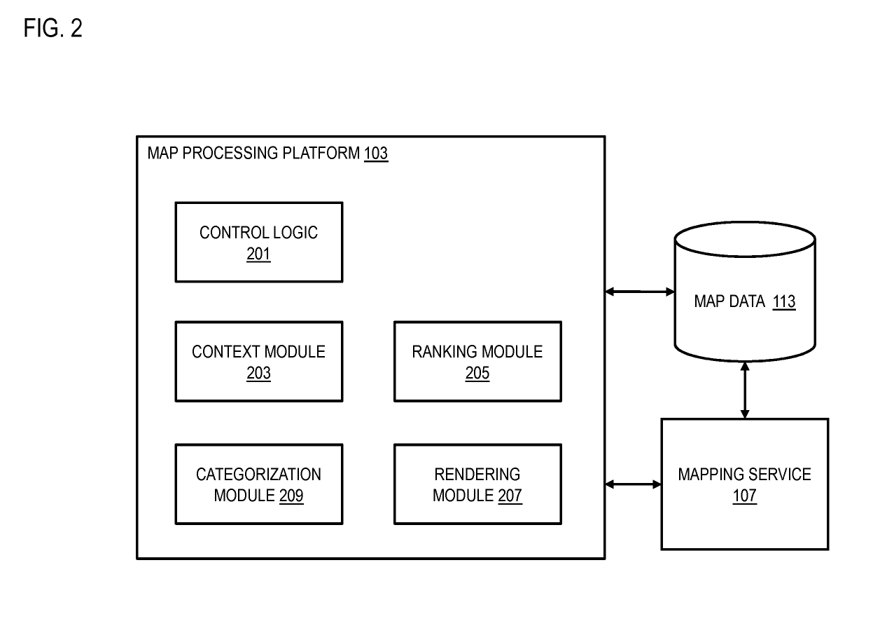

FIG. 2 is a diagram of the components of map processing platform 103, according to one embodiment. By way of example, the map processing platform 103 includes one or more components for providing expeditious rendering of results of a user query for information. It is contemplated that the functions of these components may be combined in one or more components or performed by other components of equivalent functionality. In this embodiment, the map processing platform 103 includes a control logic 201, a context module 203, a ranking module 205, a rendering module 207 and a categorization module 209.

In this embodiment, the map processing platform 103 includes at least a control logic 201 which executes at least one algorithm for executing functions of the map processing platform 103. For example, the control logic 201 interacts with the context module 203 to determine context information for rendering a map. The context information directs what type of map and what map objects are important to the map. In one embodiment, the context module 203 communicates with the mapping service 107, the mapping application 109, the UE 101, the social networking service 113 or other component of the network 105 to determine context information. The context information may describe, for instance, an intended purpose of the map (e.g., tourist map, navigation map, hiking map, etc.), an environment for use of the map (e.g., walking, in a car, etc.), user interests (e.g., favorite points of interest), and the like.

The context module 203 may use a variety of mechanisms to determine the context information. In one mechanism, the context module 203 may receive direct input specifying a particular context. For example, a user may directly specify that the user would like to display a tourist map of a particular city and overlay restaurant information on top of the map.

In yet another mechanism, the context module 203 may infer a context from the location of the requestor. For example, if a user requests a contextual map while located in a shopping center, the context module 203 may infer that the context of the map is related to shopping and will place a higher level of importance on points-of-interests or other map objects related to shopping. Other indirect methods for determining context include, evaluating a recent history of online searches or recently viewed websites, evaluating recent communications (e.g., voice, text messages, and e-mails) for key words related to particular contexts, monitoring historical travel patterns or activities, or querying social networking services for context information. It is contemplated that any mechanism can be used by the context module 203 to determine context.

The context module 203 may then interact with the ranking module 205 to rank available map objects against the determined context. The ranking module 205 uses, for instance, semantic information to determine the importance or relevance of each object to the context and classify the objects according the importance. By way of example, the ranking module 205 retrieves metadata associated with each object from the map data 111. The metadata includes information such as the object's name, category (e.g., road, point of interest, water body, park, etc.), and location. The ranking module 205 then performs a semantic analysis on the metadata to determine a level of association of the metadata with determined context. This level of association, in one embodiment, represents, at least in part, the level or importance or relevance of the corresponding object to the determined context. For example, if the context is a hiking trip, the ranking module 205 may classify map objects with metadata that indicate an association with national parks in a category of higher importance than objects associated with shopping malls.

Once all of the available objects have been classified, the ranking module 205 prioritizes the rendering of the classified objects for rendering based on a user inputted query. Prioritization includes determining for rendering which points of interest are to be highlighted, either individually, or in a cluster, by determining which classifications to render as more important or to illustrate as being ranked higher. In other words, the rendering module 207 may symbolize that a particular geographic area has better results for the user query than other areas. Better results may be an area having more results, higher ranked results, or results that fit better with the user context.

In one embodiment, the rendering module 207 interacts with the mapping service and/or the mapping application 109 to render or cause, at least in part, actions that result in the rendering of the final map based on the ranking of the ranking module 205. In particular, the rendering module 207 determines what objects and in what detail can be displayed on the UE 101 given the display area available on the UE 101. Based on the level of detail available, the rendering module 207 performs or causes, at least in part, actions that result in differential rendering or scaling of the map objects to be displayed based on their associated prioritization. In one embodiment, the rendering module 207 uses various mechanisms such as clustering and graphically illustrating a ranking or number of results when compared to other results to enhance the detail for rendering search results on the map.

In certain embodiments, the mapping service 107 and/or the mapping application 109 may use a vector rendering engine to generate the final map image from the vector primitives corresponding to the map objects to be displayed. These vector primitives, for instance, are models that use, e.g., a data structure or vector-based language, to describe the appearance of map objects in a resolution independent manner. The vector rendering engine then converts these models to a digital or raster graphics image that is displayable by the UE 101.

Alternatively, the functions of the map processing platform 103 and/or the mapping service can be implemented via an access control application (e.g., a widget) (not shown) in the UE 101 according to another embodiment. Widgets are light-weight applications, and provide a convenient means for presenting information and accessing services. It is contemplated that the functions of these components may be combined in one or more components or performed by other components of equivalent functionality. In this embodiment, the access control application includes modules similar to those of the map processing platform 103, as previously described. To avoid data transmission costs as well as save time and battery, its control logic can fetch map data cached or stored in its own database, without requesting data from any servers or external platforms, such as the map processing platform 103 or the mapping service 107. Usually, if the UE 101 is online, data queries are made to online search server backends, and once the device is off-line, searches are made to off-line indexes locally.

In one embodiment, the categorization module 209 receives context information such as points of interest and classifies the points of interest into various categories. For instance, a plurality of restaurants may be classified as food, theatres as culture, stores and malls as shopping, etc. The control logic 201 may consider a categorical input from a user to search for a particular category. Then, based on the categorical input, instruct the rendering module 207 to render a clustering of search results to simplify the view and amount of data necessary to present the clustered view to a user. The user may then select any cluster that is presented to get more detail about the contents of that cluster. For instance, if a map illustrates search results for different locations, each location having a respective cluster indicating a number of restaurants in that area, then the user may select a cluster to get more information about the restaurants that correspond with that higher level cluster view. The greater details may be exact location of the particular points of interest, a zoomed-in view of the area that has more clusters because the number of search results are still too many to illustrate, details about the specific point of interest, such as address, ratings, review, menu, etc.

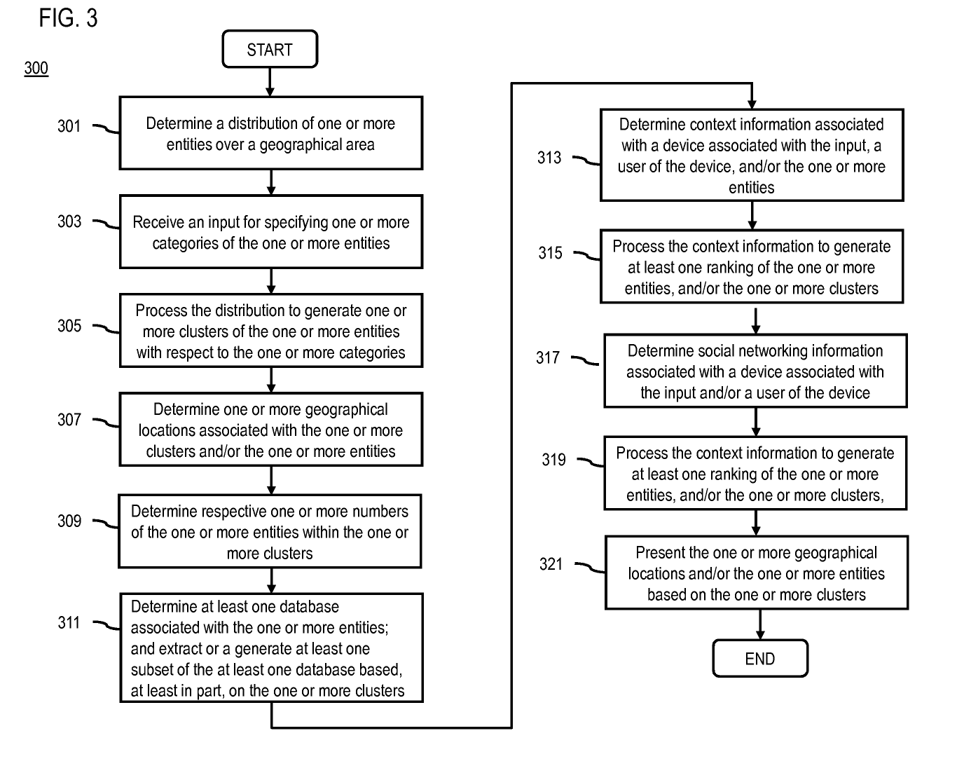

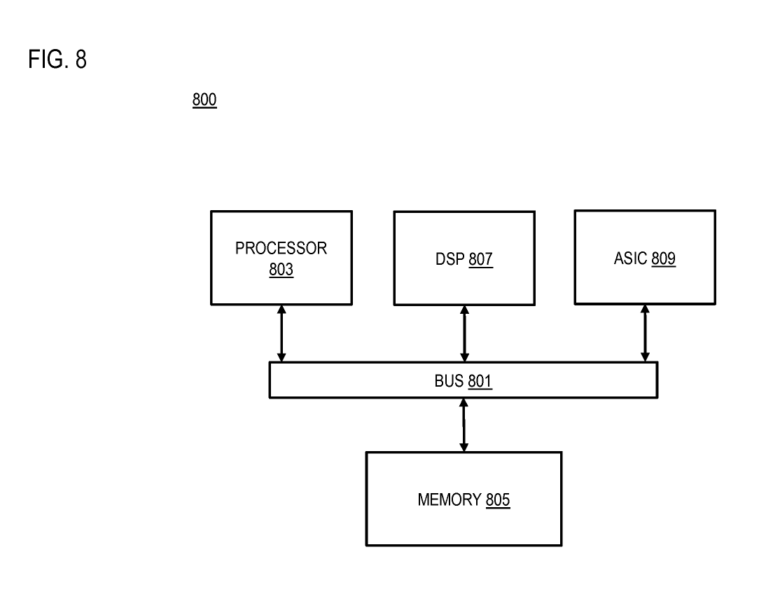

FIG. 3 is a flowchart of a process for expeditiously rendering results of a user query for information, according to one embodiment. In one embodiment, the map processing platform 103 performs the process 300 and is implemented in, for instance, a chip set including a processor and a memory as shown in FIG. 8. In step 301, the map processing platform 103 determines a distribution of one or more entities over a geographical area. The one or more entities may be any points of interest that are available. The points of interest may be found any way imaginable including, but not limited to, points of interest stored in the map data 111, in a database that is part of the social networking service 113, entities stored in the UE 101, or any other database that may be access by way of the communication network 105. The process continues to step 303 in which the map processing platform 103 receives an input from a user specifying one or more categories of interest in a particular customizable location. In other words, the user is searching for points of interest that correspond, for example, to hotels in a region. The user may want to compare different areas within a city, state, country, territory, etc. to find the area with the most and/or best hotels. The region may be varied by a search radius about a location, for example, as well as by a particular time of the search or a search for results that are based on a particular time. For example, context information may include hours of operation of a point of interest. As such, the user may want information about shopping at 9 pm. The search results may or may not be limited to results showing shops that are open at the time of the search.

The process continues to step 305 in which the map processing platform 103 processes the distribution of points of interest to generate one or more clusters of the one or more points of interest with respect to the one or more categories that are input. The process continues to step 307 in which the map processing platform 103 determines one or more geographical locations associated with the one or more clusters and/or the one or more entities. Next, the process continues to step 309 in which the map processing platform 103 determines a respective number of search results that should correspond with the one or more clusters so that the number of search results may be displayed and compared with other clusters, or be easily viewed by the user to aid in a decision to travel to a location. The process continues to step 311 in which at least one database is determined that is associated with the one or more entities/points of interest and a subset of the database may be extracted, optionally as a preprocessing operation to limit resources, based on the one or more clusters.

Next, in step 313, context information may optionally be determined that is associated with the UE 101, the user, or the one or more points of interest. Such context information may be any of location, reviews, rating, user preferences, etc. In step 315, the map processing platform 103 processes the context information to generate at least one ranking of the one or more entities, and/or the one or more clusters. In step 317, the map processing platform 103 may optionally query the social networking service 113 to get information associated with the UE 101 and/or the user, and/or context information about the point of interest. The process continues to step 319 in which the map processing platform 103 processes the context information to generate at least one ranking of the one or more entities and/or the one or more clusters. Next, in step 321, one or more of the geographical locations and or the one or more entities based on the clusters may be presented. The presentation may be by way of any user interface or display. The presentation may also highlight some area of interest as being better or in better alignment with the user context than other results.

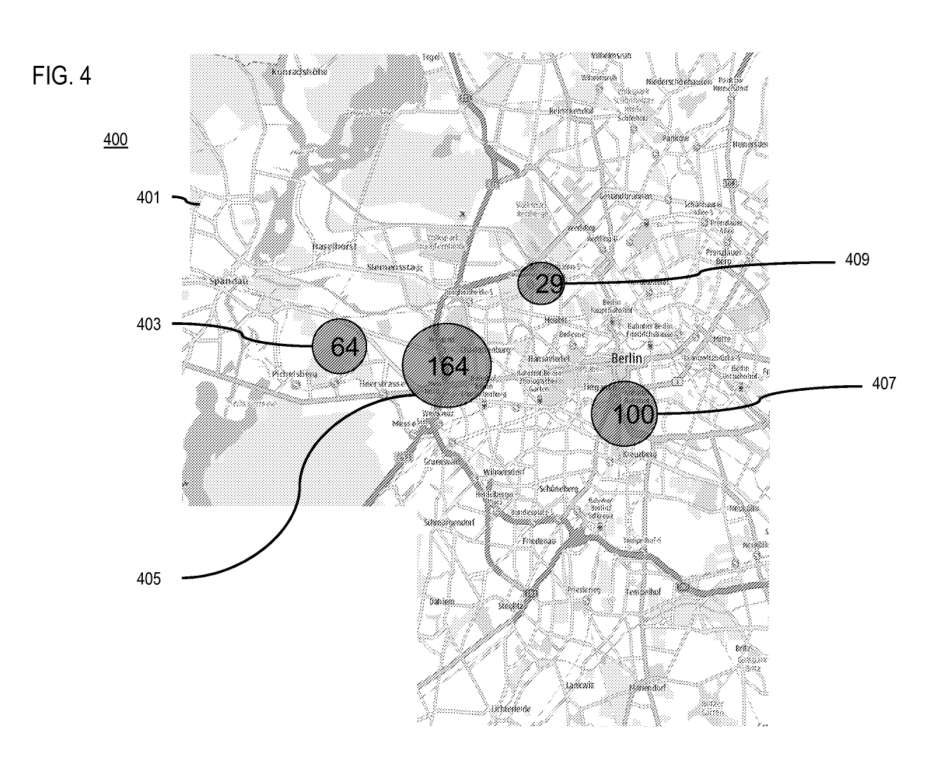

FIG. 4 is a diagram of a user interface 400 utilized in the processes of FIG. 3, according to one embodiment. The user interface 400 provides a display of search results on a map 401. In this example, the map processing platform 103 received a query for information about a particular point of interest near Berlin. The map processing platform 103 yielded 357 total results in the area illustrated on the map, but because the results would be overwhelming to a user, the map processing platform 103 decided to cluster the results into four clusters 403-409, each illustrating a high level view of the results that are available for the particular area over which the clusters 403-409 are laid. Cluster 401 illustrates that in that area of the map there are 64 hits that correspond to the user search, cluster 405 illustrates that in that area of the map there are 164 hits that correspond to the user search, cluster 407 illustrates that in that area of the map there are 100 hits that correspond to the user search and cluster 409 illustrates that in that area of the map there are 29 hits that correspond to the user search. Each of the clusters 403-409 are depicted as circles for illustration purposes, but they may be depicted by any shape having any number of sides and/or points of connection. Each of the clusters 403-409 are also illustrated as having a variable size to convey that a larger number of search results appear within the larger cluster than other smaller graphical clusters. However, the opposite may be true for purposes of illustration, or the sizes may be identical. The results and/or clusters may also be displayed by any other means such as varying the size of the text within a graphical cluster, or by simply displaying text without a circle, for example. The text may present the number of results within the cluster, or the text may simply indicate in some way that results are present at a location by highlighting the name of the region. For example, one name could be written in bold, or had a larger font size than other names of regions on a map. Or, the name having the most results could be a font that is a different color than other names of areas on the map.

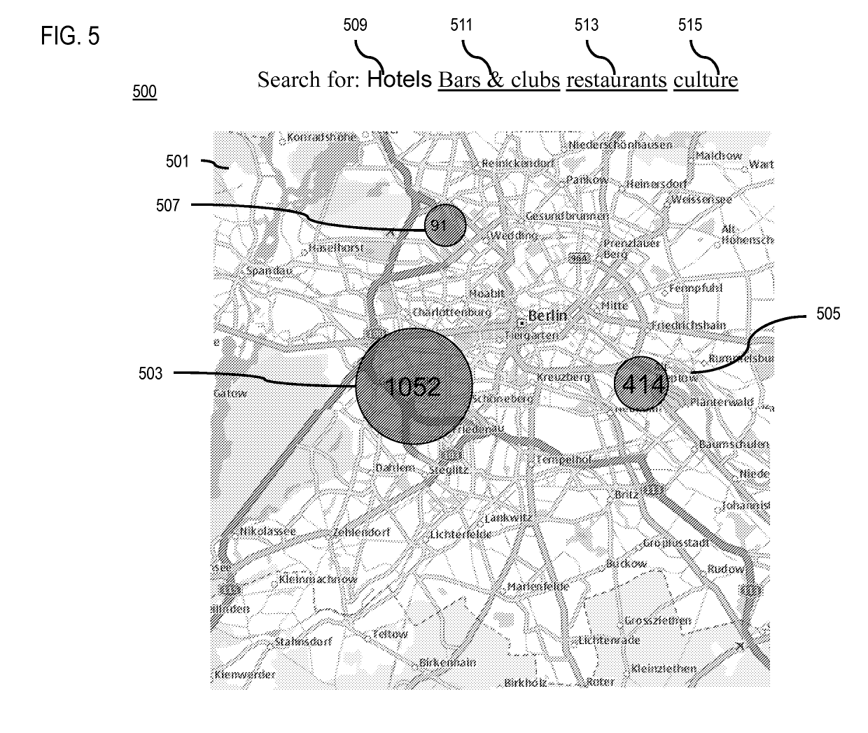

FIG. 5 is a diagram of a user interface 500 utilized in the processes of FIG. 3, according to one embodiment. The user interface 500, in this example, illustrates a series of clusters 503-507 on a map 501. The clusters 503-507, in this example, are illustrating search results for hotels near Berlin. The clusters 503-507 are illustrated such that their overall size varies based on the number of results that are present within a respective cluster. However, the overall size could indicate that a better search result may be found in a particular cluster based on the context information about the user, the location and the points of interest. The context information may include, as discussed above, a rating, a frequency of visits by the user to a particular point of interest or location, a frequency of queries run by the user and/or others for a location or point of interest, or any combination thereof. The context information may also continuously be updated and stored based on how many times a user or a plurality of users of a social network or the system point a UE 101 at various points of interest. The idea is that the continuous updating and building of a context database provides for a pipeline of information that is readily available with as little processing required to reduce rendering time of search results. The search itself may be varied by selecting any of the exemplary search items 509-515 which may be individually selected, or combined to yield further search results. In this example, search items 509-515 correspond to “hotels,” “bars & clubs,” “restaurants” and “culture.” These search items may be changed to any topic of interest to a user by way of a user interface, and they may be fixed or variable based on the user's preferences. Further, the map 501 may be any of a 2D display and/or a 3D display which may be any of a mapping display, a navigation display, an augmented reality display, a mixed reality display, a virtual reality display, or any combination thereof.

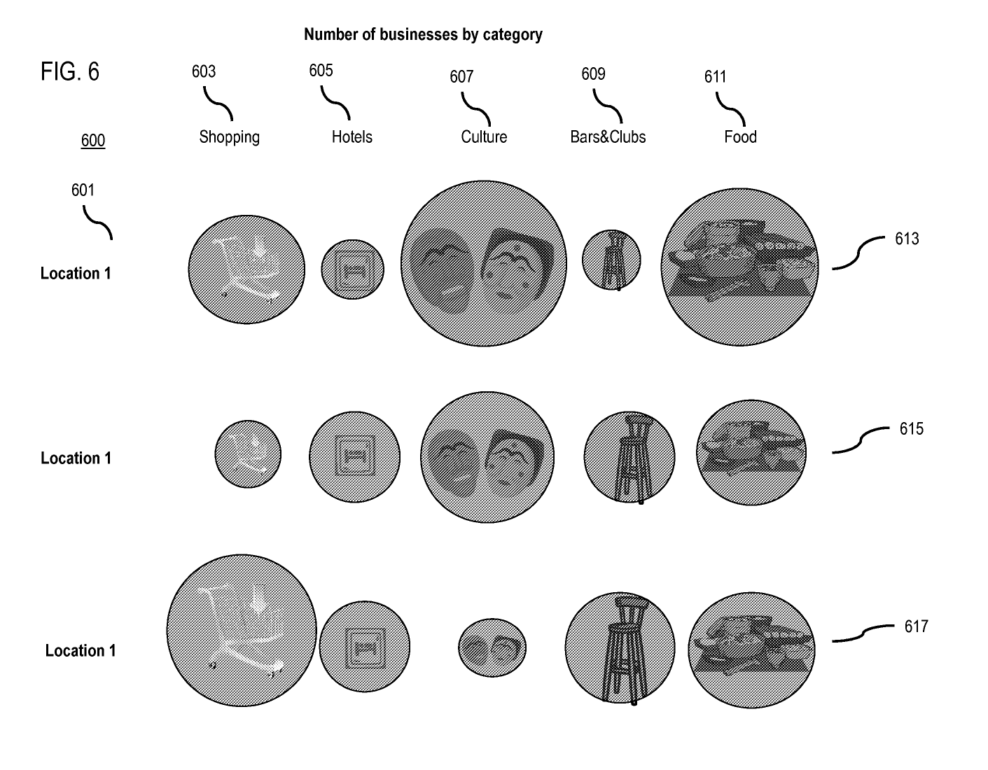

FIG. 6 is a diagram of a user interface 600 utilized in the processes of FIG. 3, according to one embodiment. The user interface 600, in this example, is a list that enables a user to view and compare search results 613-617 for respective locations for multiple categories so that the user may decide which location to visit. The search results are clustered, but are varied by size without text in this example to illustrate a number of results for each cluster, a ranking of results, or any combination thereof and how they compare to the other results for different locations and/or categories 603-611. The clusters may also be illustrated by use of text or numbers to convey information. The user may also select any of the clusters to get more information about the clusters and any information about points of interest that they may be referring to.

The processes described herein for expeditiously rendering results of a user query for information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

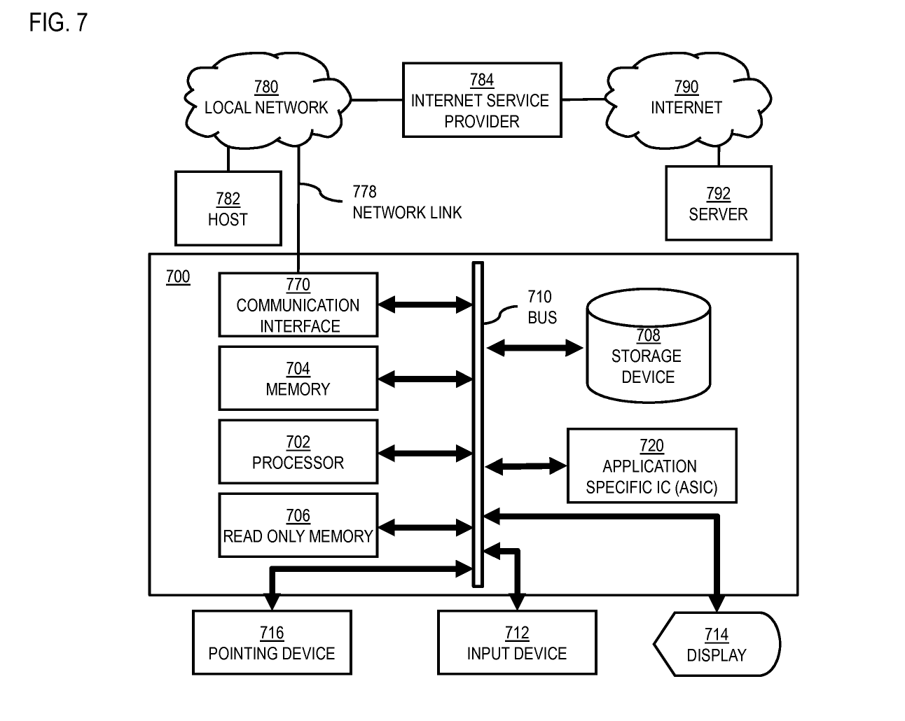

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to expeditiously render results of a user query for information as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of expeditiously rendering results of a user query for information.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to expeditiously render results of a user query for information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for expeditiously rendering results of a user query for information. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for expeditiously rendering results of a user query for information, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for expeditiously rendering results of a user query for information to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to expeditiously render results of a user query for information as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of expeditiously rendering results of a user query for information.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to expeditiously rendering results of a user query for information. The memory 805 also stores the data associated with or generated by the execution of the inventive steps.

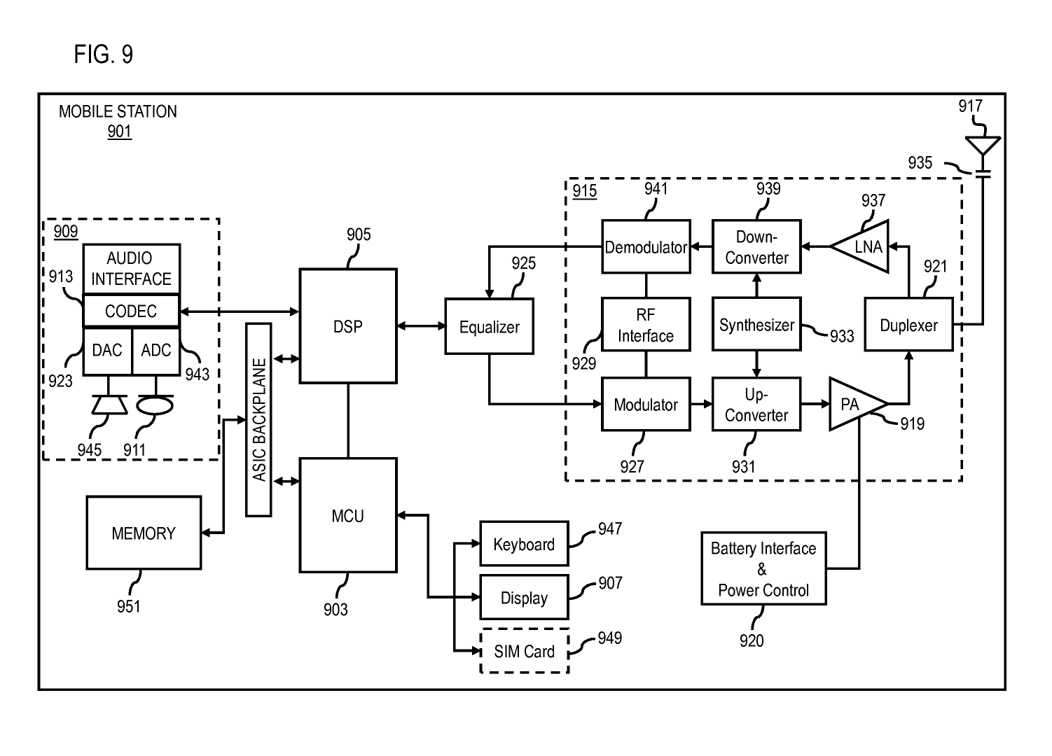

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of expeditiously rendering results of a user query for information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of expeditiously rendering results of a user query for information. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to expeditiously rendering results of a user query for information. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a distribution of one or more entities over a geographical area;
an input for specifying one or more categories of the one or more entities;
a processing of the distribution to generate one or more clusters of the one or more entities with respect to the one or more categories;
one or more geographical locations associated with the one or more clusters, the one or more entities, or a combination thereof; and
a rendering or one or more graphical presentations of the one or more geographical locations, the one or more entities, or a combination thereof based, at least in part, on the one or more clusters.

2. A method of claim 1, wherein the (1) data and/or (2) information and/or (3) at least one signal are further based, at least in part, on the following:
respective one or more numbers of the one or more entities within the one or more clusters,
wherein one or more characteristics of the one or more graphical presentations is based, at least in part, on the one or more numbers.

3. A method of claim 1, wherein the (1) data and/or (2) information and/or (3) at least one signal are further based, at least in part, on the following:
at least one database associated with the one or more entities; and
an extraction or a generation of at least one subset of the at least one database based, at least in part, on the one or more clusters.

4. A method of claim 3, wherein the (1) data and/or (2) information and/or (3) at least one signal are further based, at least in part, on the following:
the extraction or the generation of the at least one subset caused, at least in part, as part of one or more preprocessing operations.

5. A method of claim 1, wherein the (1) data and/or (2) information and/or (3) at least one signal are further based, at least in part, on the following:
context information associated with a device associated with the input, a user of the device, the one or more entities, or a combination thereof,
wherein the one or more clusters are generated based, at least in part, on the context information.

6. A method of claim 4, wherein the (1) data and/or (2) information and/or (3) at least one signal are further based, at least in part, on the following:
a processing of the context information to generate at least one ranking of the one or more entities, the one or more clusters, or a combination thereof,
wherein the rendering of the one or more graphical presentations are based, at least in part, on the ranking.

7. A method of claim 4, wherein the context information includes, at least in part, a rating, a frequency of visits, a frequency of queries, or a combination thereof.

8. A method of claim 1, wherein the (1) data and/or (2) information and/or (3) at least one signal are further based, at least in part, on the following:
social networking information associated with a device associated with the input, a user of the device, or a combination thereof,
wherein the one or more clusters are generated based, at least in part, on the social networking information.

9. A method of claim 1, wherein the graphical representations includes, at least in part, one or more text labels, one or more icons, one or more symbols, or a combination thereof associated with the one or more clusters, the one or more entities, the one or more categories, or a combination thereof.

10. A method of claim 1, wherein the one or more graphical presentations are rendered in a two-dimensional display, a three-dimensional display, or a combination thereof including, at least in part, a mapping display, a navigation display, an augmented reality display, a mixed reality display, a virtual reality display, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a distribution of one or more entities over a geographical area;
receive an input for specifying one or more categories of the one or more entities;
process and/or facilitate a processing of the distribution to generate one or more clusters of the one or more entities with respect to the one or more categories;
determine one or more geographical locations associated with the one or more clusters, the one or more entities, or a combination thereof; and
render or one or more graphical presentations of the one or more geographical locations, the one or more entities, or a combination thereof based, at least in part, on the one or more clusters.

12. An apparatus of claim 11, wherein the apparatus is further caused to:
determine respective one or more numbers of the one or more entities within the one or more clusters,
wherein one or more characteristics of the one or more graphical presentations is based, at least in part, on the one or more numbers.

13. An apparatus of claim 11, wherein the apparatus is further caused to:
determine at least one database associated with the one or more entities; and
cause, at least in part, an extraction or a generation of at least one subset of the at least one database based, at least in part, on the one or more clusters.

14. An apparatus of claim 13, wherein the apparatus is further caused to:
cause, at least in part, the extraction or the generation of the at least one subset as part of one or more preprocessing operations.

15. An apparatus of claim 11, wherein the apparatus is further caused to:
determine context information associated with a device associated with the input, a user of the device, the one or more entities, or a combination thereof,
wherein the one or more clusters are generated based, at least in part, on the context information.

16. An apparatus of claim 14, wherein the apparatus is further caused to:
process and/or facilitate a processing of the context information to generate at least one ranking of the one or more entities, the one or more clusters, or a combination thereof,
wherein the rendering of the one or more graphical presentations are based, at least in part, on the ranking.

17. An apparatus of claim 14, wherein the context information includes, at least in part, a rating, a frequency of visits, a frequency of queries, or a combination thereof.

18. An apparatus of claim 11, wherein the apparatus is further caused to:
determine social networking information associated with a device associated with the input, a user of the device, or a combination thereof,
wherein the one or more clusters are generated based, at least in part, on the social networking information.

19. An apparatus of claim 11, wherein the graphical representations includes, at least in part, one or more text labels, one or more icons, one or more symbols, or a combination thereof associated with the one or more clusters, the one or more entities, the one or more categories, or a combination thereof.

20. An apparatus of claim 11, wherein the one or more graphical presentations are rendered in a two-dimensional display, a three-dimensional display, or a combination thereof including, at least in part, a mapping display, a navigation display, an augmented reality display, a mixed reality display, a virtual reality display, or a combination thereof.
